(19) United States
(12) Patent Application Publication
(10) Pub. No.: US 2016/0096636 A1
(43) Pub. Date: Apr. 7, 2016

(54) Electromagnetic Tow System For Nonpowered Ultralight Aircraft

(71) Applicant: Gregory Bryl, Washington, DC (US)

(72) Inventor: Gregory Bryl, Washington, DC (US)

(21) Appl. No.: 14/506,628

(22) Filed: Oct. 4, 2014

(51) Int. Cl. B64F 1/08

(52) U.S. Cl. CPC B64F 1/08

(57) ABSTRACT

An electromagnetic tow system for towing nonpowered ultralight aircraft that allows for towing under constant and controlled tow line tension using both pay-in and pay-out tow methods. An electric motor is mechanically connected to a winch holding the tow line and electrically connected to a power supply. When the line is paid out on tow, the motor is disconnected from its power supply and its non-field windings are shorted outright or connected through a resistor. As the motor's rotor rotates inside the motor's magnetic field (created by the motor's permanent magnets or powered stator windings) under the mechanical load of the towed aircraft, current is generated in the non-field windings of the motor, which creates braking torque opposing the mechanical rotation of the rotor and provides tow line tension. In a preferred configuration, a hub motor is used, with the winch drum side plates mounted directly onto the sides of the hub motor to serve as heat sinks cooling the motor; variable resistor is used to control the braking torque, plugging is available to increase braking torque when necessary, and the electromagnetic-braking-generated voltage and current are used to recharge the motor's portable power supply. The same motor is also used to rewind the tow line onto the spool as needed.

### BACKGROUND OF INVENTION

The instant invention relates to the field of aviation. In geographical areas without mountains, often known as flat lands, nonpowered ultralight aircraft (such as paragliders and hang gliders) must be launched into flight by towing aloft. During such towing, the aircraft is connected to several thousand feet of tow line held by a winch drum. By pulling on the line, the aircraft is towed aloft to target altitude, whereby the line is released by the pilot to commence free flight.

The two primary methods used for towing nonpowered ultralight aircraft aloft are known as a “pay-in” method and a “pay-out” method. Under the pay-in method, several thousand feet of tow line is first stretched out on the ground, with one end connected to the pilot and the other to the winch. The winch then pays the tow line in spooling it onto the drum (hence the name, pay-in), thus pulling the aircraft and towing it aloft. By contrast, under the pay-out method, the pilot is towed by a winch mounted on a vehicle (or a boat), with the line being paid out (unspooled from the reel) under tension as the tow vehicle moves forward pulling the aircraft. The aircraft is pulled under more or less constant tension, with the tow line increasing in length until the target altitude is reached and the line is released.

Both methods of towing are quite common. A pay-in system requires lots of space to stretch out the line in the beginning and is often used at small airports. A pay-out system often requires less space and allows for higher tows, but needs a road or other terrain that allows for driving. Both systems require producing and maintaining controlled line tension and smooth spooling (pay-in) or unspooling (pay-out) of the tow line.

The current pay-in systems use a single engine, usually a gas motor, to spin the winch drum to pay in the tow line. When the line is released by the pilot, it can be fully reeled in onto the winch drum by the same engine. To stretch the line out once again (for further tows), an ATV or similar small vehicle is used. On the other hand, in pay-out systems, only a bit of line is laid out in the beginning, and a braking mechanism is used at the winch end to maintain line tension as the line is unspooled from the winch. To maintain line tension during unspooling, pay-out tow systems use a friction braking or a hydraulic braking mechanism. A friction brake must absorb lots of heat and, as the tow progresses, starts to have slipping problems due to high accumulated heat. A hydraulic braking mechanism has better heat absorption and provides smoother braking and thus better constant line tension, and is used on most commercial-grade pay-out tow systems. However, both hydraulic and friction tow systems must use two primary mechanisms: a braking mechanism for paying out line under tension and a winding mechanism for reeling the same line back in. As a result, such systems, especially hydraulic ones, are bulky, expensive, cannot be handled easily by one or two people, and require significant maintenance.

### SUMMARY OF INVENTION

The instant electromagnetic tow system simplifies the prior systems by combining and packaging both braking and reeling functions into one compact and simple mechanism, which is less mechanically complex, less bulky, less costly, and much more manageable for small groups. It is also generally smoother than the current systems because it does not utilize friction to produce braking torque and the torque can be precisely regulated by virtue of electrical circuits.

The invention uses a single electric motor for both braking torque during line payout and driving force during line pay-in. The invention uses electric braking properties of a DC motor run as a generator to smoothly and without friction pay out the tow line under controlled tension. The invention then uses the same DC motor to reel in the tow line afterwards. The same motor is also used to accomplish the pay-in tow mode. This design results in a universal, yet simple, tow system that combines all the functions of the current tow systems and that is significantly more compact, light-weight, and more manageable than the current systems. The electromagnetic tow system thus makes nonpowered free flight much more accessible than before.

Additional features of the invention include the use of aluminum side plates of the winch drum to double up as heat sinks for the electric motor (which results in higher possible operational loads relative to the motor's power and the use of smaller, lighter motors) and the capture of the converted mechanical energy to recharge the batteries powering the motor.

### BRIEF DESCRIPTION OF THE DRAWINGS

FIG. 1 is a schematic of a paraglider towed aloft under a pay-out method.

FIG. 2 is a side view of the tow system embodying the invention in its preferred configuration.

FIG. 3 is a front view of the tow system embodying the invention in its preferred configuration.

FIG. 4 is a diagram of the electrical circuit of the electromagnetic tow system.

### DETAILED DESCRIPTION OF THE INVENTION

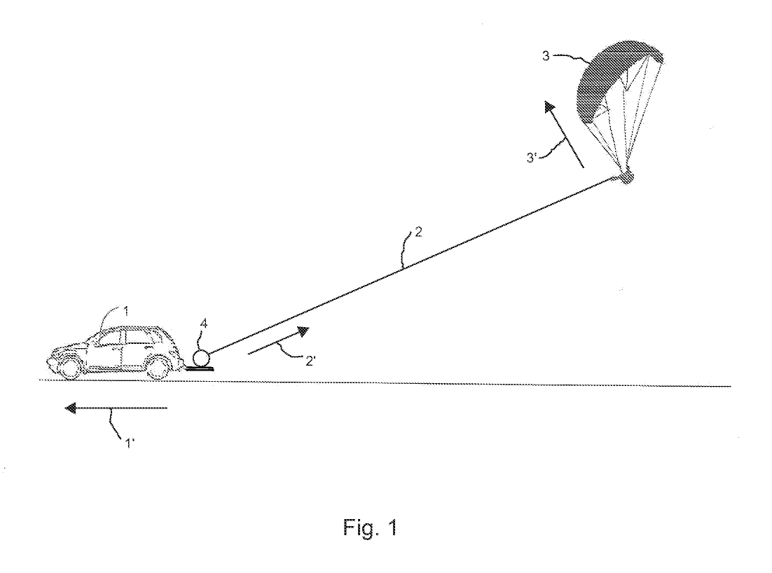

FIG. 1 illustrates a typical tow of a paraglider 3 using a payout method and employing a moving tow vehicle 1 on which the tow system 4 is mounted, with the tow line 2 being paid out during a tow. Arrow 1′ indicates the direction of the tow vehicle's motion. Arrow 2′ indicates the direction in which the tow line is paid out from the tow system 4. Arrow 3′ indicates the direction of the flight of the towed paraglider 3 during the tow.

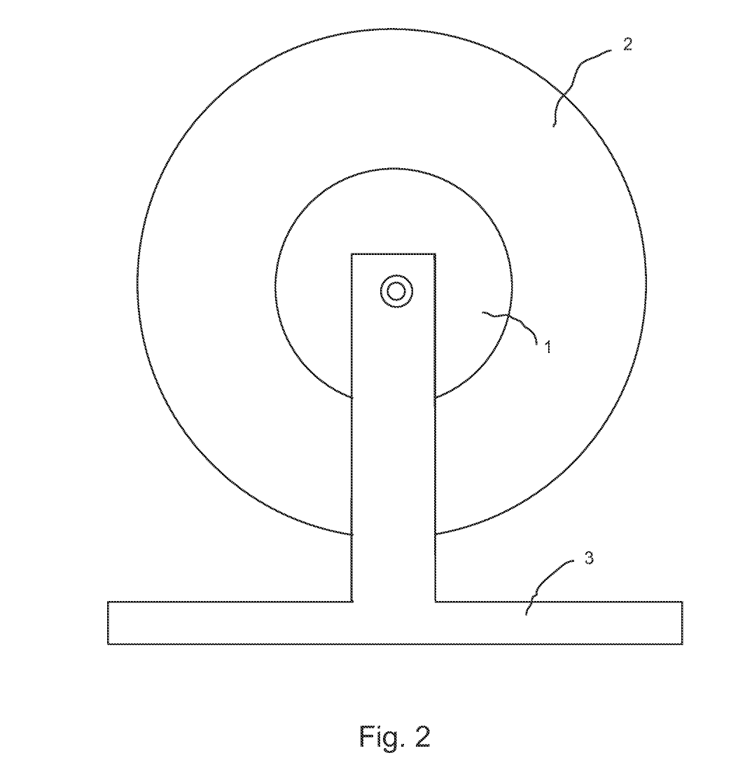

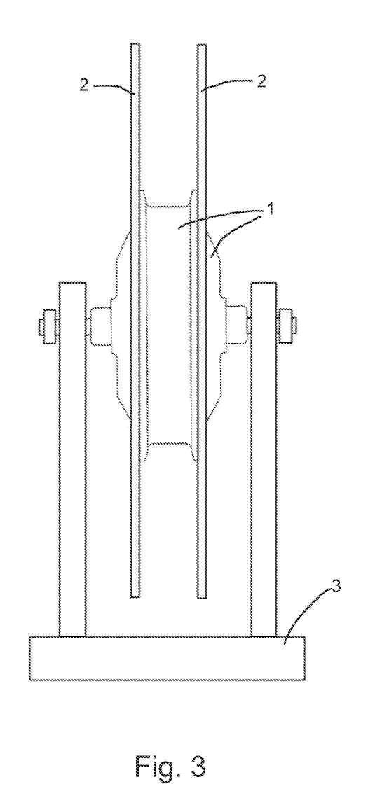

FIG. 2 and FIG. 3 illustrate a close-up of the electromagnetic tow system itself in its preferred configuration. A DC permanent magnet hub motor 1 is mounted on a frame 3 and is connected to a power supply (not shown). The round aluminum side plates 2 comprising the winch drum are mounted directly onto the sides of the hub motor 1 to form the winch drum. The drum holds the tow line (not shown), and its side plates 2 double up as heat sinks for the hub motor 1.

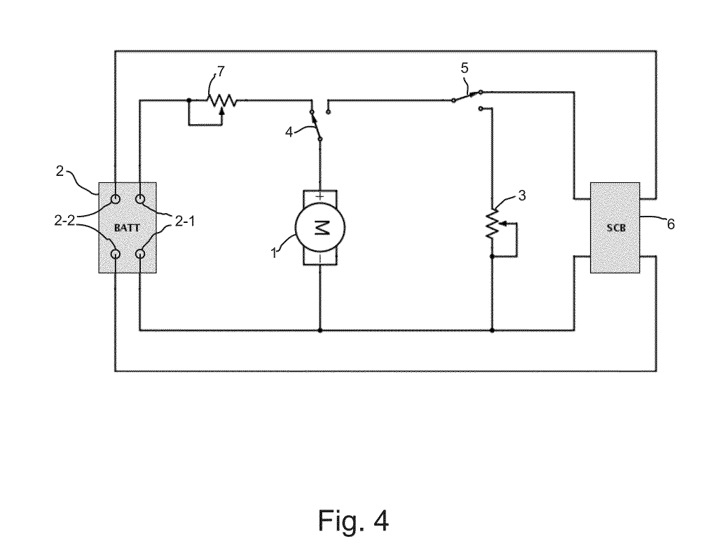

FIG. 4 illustrates the electrical circuit that facilitates the operation of the electromagnetic tow system. During a pay-out tow, the terminals of the motor (“M”) 1 are connected together (shorted) or connected to a variable resistor 3 (optional) or a semiconductor charging block (“SCB”) 6 (optional), forming a closed circuit. This connection is accomplished using the switch 5. The semiconductor block 6 is also connected to the charging terminals 2-2 of the rechargeable battery 2 that powers the motor 1. When the tow system moves with the tow vehicle, while a paraglider is attached to the free end of the tow line (as discussed earlier with respect to FIG. 1), the motor 1 is mechanically loaded by the towed aircraft (as discussed earlier with respect to FIG. 1) and its rotor starts to rotate. The rotor rotates inside the motor's magnetic field produced by the motor's permanent magnets (which can alternatively be electro-magnets), an electric current is generated in the motor's non-field windings, and a torque in the direction opposite of the mechanically-induced rotation (hence, braking torque) is produced. The braking torque is regulated by choosing the resistance of resistor 3 (whether variable or permanent), whose resistance (or range of resistance) is chosen based on the power rating of the motor 1 and its other characteristics.

As the tow vehicle moves forward faster than the towed aircraft, the tow line is unspooled under the mechanical load of the towed aircraft, (as shown in and discussed with respect to FIG. 1). The line is unspooled (paid out) by said mechanical load, and the unspooling is opposed by the braking torque induced as described above. This results in gradual and controlled paying out of the tow line under desired tension. The tension can be adjusted in real time via the optional variable resistor (FIG. 4, element 3) and also by speeding up or slowing down the tow vehicle (FIG. 1, element 1).

Referring to FIG. 4 again, if the motor's maximum braking torque is too weak to maintain adequate line tension (due to a heavier towed aircraft), the motor can be powered by supplying additional current from the motor's power supply in such a way that it's rotating torque will oppose the mechanical rotation caused by the unspooling of the tow line. This powering is accomplished by using the switch 4 to close the circuit comprising the motor 1, variable resistor 7, and the battery discharge terminals 2-1. Then, the powered motor's active torque will oppose the mechanical load torque, resulting in greater braking force. Such active torque is regulated by the variable resistor 7.

When the desired altitude of the towed aircraft is reached, the tow line is released by the pilot and needs to be spooled back onto the drum. The operator gives power to the motor 1 using the switch 4 and the motor 1 rotates the winch drum spooling in the tow line. The reel-in speed is again regulated by the variable resistor 7.

With this design and operation, pay-in tows are easily accomplished as well. Under a pay-in method, the line is first unspooled from the winch drum and laid out on the ground. The aircraft to be towed is attached to the free end of the tow line. The operator then powers the motor using the switch 4 and pays in the tow line causing the aircraft to gain altitude. The tow tension in this case is regulated by the variable resistor 7. After the tow line is released, it can be stretched out again for another pay-in tow or reeled in back onto the winch drum the same way it was being reeled in during the pay-in tow.

The invention operates by converting the mechanical energy of the load supplied by the towed aircraft into electrical energy of the current in the motor's non-field windings, which current creates a force opposing the initial mechanical rotation and which current is dissipated in the windings and balancing resistors and/or into charging the motor's power supply battery. Because such braking force is electromagnetically induced and frictionless, it is more constant and more smooth compared to that of the current systems. It is also more precisely controlled because it is controlled by setting parameters of the electrical circuits rather than by mechanically setting braking friction or hydraulic liquid pressure.

During the tows using the invention, the side plates 2 (FIGS. 2 & 3) of the drum spin in open air and provide convenient cooling of the motor 1, as the motor produces braking torque or driving torque. Due to such cooling, a much smaller and lighter motor can be used, which enhances the portability, manageability, and reliability of the system.

A preferred embodiment of the invention has been described herein by way of example only. Without intent to be limited by any such description, the invention has been described in relation to a winch that is built around a single electric hub motor which supplies both the electromagnetic braking torque to pay out line and the driving torque to pay in line.

Even if a non-hub electric motor is used (in combination with a chain or belt and without the winch's side plates doubling up as heat sinks), where in such motor is mechanically connected to a separate winch using a belt or a chain, it is still advantageous to utilize the non-friction nature of the electromagnetic braking produced by such motor in towing nonpowered ultralight aircraft. With the instant invention, one is able to use an electric motor to maintain constant and precisely-regulated pay-out line tension and then use the same motor for any reel-in/pay-in functions. Most significantly, this avoids having two separate mechanisms a braking mechanism for pay-out and a winding mechanism for pay-in, as has been the case with all current tow systems.

Additionally, an electric motor need not necessarily be a permanent magnet motor. It can be any other DC, or even an AC, motor (although the use of an AC motor is unlikely in light of the tow system's need to be portable). Likewise, other features such as plugging (to increase braking torque beyond that produced in a non-powered mode) and variable resistors to precisely regulate the braking torque and reel-in speed are optional.

The invention is therefore intended to include all such variations and adaptations without departing from the scope of the invention as set out in the claims set forth elsewhere herein.

1. An electromagnetic tow system comprising
an electric motor electrically connected to a power supply and mechanically connected to a winch (which holds a certain amount of tow line), with both the motor and winch mounted on a frame, wherein the motor transmits torque to the winch and is either braking or driving the winch as the tow line is paid out or paid in under controlled tension, and where
braking is done by running the motor as an electric generator under the mechanical load supplied by the towed aircraft, with the motor's non-field windings disconnected from the power supply and connected into a closed circuit with variable resistance, whereas
driving is done by using the motor in its regular configuration in which the motor is connected to its power supply and transmits its driving torque to the winch.

2. The electromagnetic tow system of claim 1, wherein the motor is a DC motor.

3. The electromagnetic tow system of claim 1, wherein the motor is a DC permanent magnet motor.

4. The electromagnetic tow system of claim 1, wherein the motor transmits torque to the winch via a chain or a belt drive-train.

5. The electromagnetic tow system of claim 1, wherein the motor is a hub motor serving as the hub of the winch drum and thus driving the winch directly, with the rotating axis of the motor and the rotating axis of the winch drum being the same.

6. The electromagnetic tow system of claim 5, wherein the side plates of the winch drum, made of aluminum (or other metal having a comparable combination of tensile strength and heat conductivity), are mounted directly onto the sides of the hub motor to serve as the motor's heat sinks cooling the motor.

7. The electromagnetic tow system of claim 1, wherein braking is further accomplished by plugging the motor, i.e. by so connecting the motor to its power supply so that it transmits driving torque to the winch in the direction opposing the torque exerted by the towed aircraft through the tow line, i.e., in this particular configuration, the motor applies its active rotating torque generated by the motor's power supply to oppose the mechanical rotation of the winch, but still rotates in the direction of the mechanically applied torque.

8. The electromagnetic tow system of claim 7, where a balancing resistor or resistors, whether constant or variable, are added to dissipate excess current.

9. The electromagnetic tow system of claim 1, where the power supply is a rechargeable battery.

10. The electromagnetic tow system of claim 9, wherein electrical energy generated by the electromagnetic braking of the non-powered motor whose rotor is spinning under the load supplied by the towed aircraft is further captured and used to recharge the rechargeable battery by connecting the motor's non-field windings to a semiconductor charging block that is connected to the battery's charging terminals and that transforms the generated voltage and current into a form compatible with the voltage and current used to recharge the battery via its standard charger.

11. The electromagnetic tow system of claim 1, wherein the motor is operated via a remote control by the towed pilot.
